(19) United States
(12) Patent Application Publication
(10) Pub. No.: US 2012/0016835 A1
(43) Pub. Date: Jan. 19, 2012

(54) Universal database - cDB

(76) Inventors: Amarjit Singh, Milpitas, CA (US); Karamjit Singh, SAS Nagar (IN)

(21) Appl. No.: 12/776,247

(22) Filed: Jul. 15, 2010

(51) Int. Cl. G06F 17/30

(52) U.S. Cl. 707/603; 707/E17.005

(57) ABSTRACT

Cloud database is a single integrated universal database for enterprises, which provides a single database for online analytical processing (OLAP) and online transaction processing (OLTP) capabilities on the same database which stores real data. Cloud Database (cDB) can use any column oriented distributed database hosted on cluster of distributed file system to store the data into files. cDB uses divide and conquer principle to process the analytical queries. cDB hosts databases for various application which uses different database of different vendors. cDB adapter is interface between the enterprise application and cDB and handles query processing for the application.

### TECHNICAL FIELD

This invention relates to computer database in which single universal database is used for both business intelligence/analytics and transaction processing in real time.

### cDB BACKGROUND

In enterprises, multiple databases are setup and maintained and many of them are used to provide online transaction processing to handle daily data entries and query processing. Some of databases are maintained as staging environment and backup purposes.

For business intelligence and analytics separate servers of databases are created called data warehouses. Data ware houses uses special format of the database objects to store the information in a particular pattern. Data warehouses uses the same OLTP databases as a source to extract, transform and load (ETL) the useful information into the warehouse.

Data in data warehouses is kept in a typical format of dimensions, cubes etc. to serve the data mining or analytics queries. Same OLTP data is copied or duplicated in various instances of different databases in the form of Data Warehouses.

Keeping the data warehouse upto date can be difficult because scheduled and batch based ETL processes are efficient when run within few hours or days of data updates. Other disadvantage is different databases of data models require pre-processing before storing into database warehouse.

Therefore, database warehouses do not have most recent data and restrict the real time analysis and information extraction thus effect the enterprise decision. Three separate layers or stages of same data are maintained in the current scenario.

Current RDBMS are not scalable, which can handle tera bytes of the data and scale onto multiple servers on different regions. Moreover, enterprises maintain multiple databases of different vendors to run their applications. There is no single universal database for all type of storage required for business applications.

### DETAILED DESCRIPTION

cDB is designed in such a manner that it can handle transaction and analytical queries at the same time on the real data. Separate database for data warehouse is not required to keep the data into particular pattern in the form of cubes and dimensions to process the analytical queries.

cDB can use any available column database to store the data such as Hbase by Hadoop. However, cDB has its own import program to convert the existing databases of the applications into cDB data files. cDB adapters are configured to accept the calls from applications and they also provide interface between application and cDB data files. cDB adapter also provides the database connectivity and query processing to applications.

Concurrency and log manager of cDB provides the safety to every transaction processing in the case of transaction failure, rollback conditions. cDB caching is responsible to maintain the most recent data into main memory to provide fast access to subsequent calls of same queries.

cDB database stores the data into files and these files are used to process the analytical queries or programs. Analytical queries on cDB are processed using Divide-and-Conquer principle, these smalls programs/sub-queries of analytical query are executed on multiple nodes at same time on the ranges of data of the tables. After processing the sub-program on different nodes, results are merged to produce the net output for that analytical query.

cDB is single universal unified database solution for enterprises, which is used to provide storage solution for different enterprise applications.

### BREIF DESCRIPTION OF THE DRAWINGS

FIG. 1 represents cDB as a single universal database for OLTP and OLAP. In FIG. 1, components 1,2,3,4 and 5 are few example applications that can use cDB to store information. Component 12 is single universal database and each application stores its data into datastore DB1, DB2, DB3, DB4, DB5 shown as component 7, 8, 9, 10 and 11. Component 14 is business intelligence (Data Mining, OLAP Analysis) componet and is used to extract the information from cDB datastores and translate it into useful reporting information which is further accessible through the lookup base or user interface.

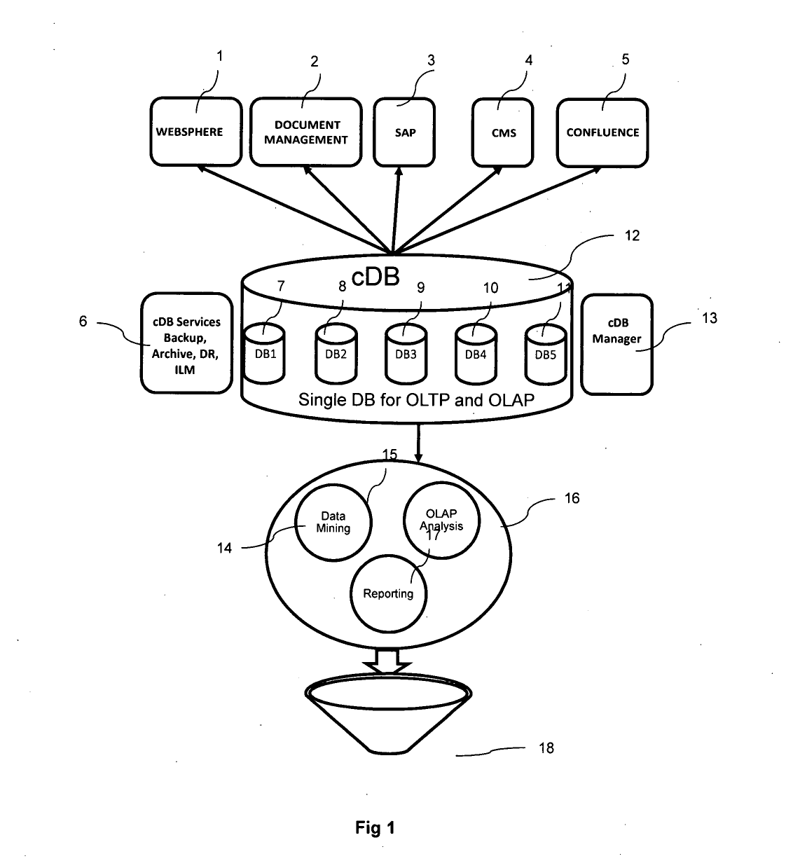

What is claimed:

1. A single universal database for both transaction processing in real time and business intelligence/analytics on a cloud or a cluster of computers:—
Each application using this database would have only one database for transactions and business intelligence analysis and reporting.
